(19) United States
(12) Patent Application Publication
(10) Pub. No.: US 2025/0207695 A1
(43) Pub. Date: Jun. 26, 2025

(54) NEW TYPE OF WATER PIPE

(71) Applicants: Chi Zhang, Yangjiang (CN); Song Chen, Yangjiang (CN)

(72) Inventors: Chi Zhang, Yangjiang (CN); Song Chen, Yangjiang (CN)

(21) Appl. No.: 18/619,222

(22) Filed: Mar. 28, 2024

(30) Foreign Application Priority Data
Dec. 26, 2023 (CN) 202323570104X

(51) Int. Cl. F16L 11/112; F16L 11/12

(52) U.S. Cl. CPC F16L 11/112; F16L 11/122

(57) ABSTRACT

A new type of water pipe, comprising a compressible and foldable axial elastic corrugated inner pipe, with a drainage channel inside; the compressible and foldable axial elastic corrugated inner pipe is composed of multiple coaxial continuous annular folding structures, and can be compressed, folded, and geometrically expanded and elongated along the axial direction under the action of external forces; an braided layer; an elastic outer layer, with high elasticity; the elastic outer layer and the surface area of an outer bending ring of the compressible and foldable axial elastic corrugated inner pipe that is not covered by the elastic braided layer are connected to each other, to form a tightly integrated overall tubular structure. It can be used under both high and low water pressure conditions, can withstand high water pressure and can be extended to a set length under low water pressure conditions to meet customer needs.

### 1. FIELD OF THE INVENTION

The invention relates to the field of water pipes, specifically a new type of water pipe.

### 2. BACKGROUND TECHNOLOGY

Most of the existing telescopic water pipes on the market use textile materials for outer sleeves. For example, the disclosed invention US 2022/0003339 A1 is easy to get dirty during use and is inconvenient to clean and organize, greatly reducing its convenience. Detailed market research shows that 70% of the damage to telescopic water pipes in use is caused by strong friction and tearing between the inner pipe and the outer sleeve. After the telescopic water pipe is connected to the pressure water source, its inner elastic pipe rapidly extends and generates strong friction and tearing forces with the pleated outer sleeve; in addition, if sand, branches and other debris pass through the cloth cover during use, it will cause fatal damage to the water pipe during the extension, extension and retraction process, greatly reducing the service life of the water pipe.

In order to solve the above defects, engineering and technical personnel have done a lot of exploration: cover the outer layer of the braid with elastic rubber to prevent sand, branches and other debris from passing through the cloth cover during use, which will cause fatal injuries to the water pipe during its extension, extension and retraction. For example, the invention with the number of CN106104129B: the inner pipe is made of pleated corrugated pipe and the outer layer is covered with elastic rubber. Although it solves the problem of being easy to get dirty and inconvenient to clean and organize, this structure is not resistant to pressure and can only be used under low water pressure. Since its corrugated inner pipe has no axial elasticity, the outer rubber coating cannot be thick, otherwise it cannot achieve elongation under low water pressure.

Another problem arises from this: if the outer layer of rubber is too thin, it is easy to be damaged during use, and once the outer layer of rubber is partially damaged, the water pipe will be partially knotted and unable to stretch.

Therefore, the patented telescopic water pipe is generally unable to extend to the set length under low water pressure, and without the protection of the braided reinforcement layer under high water pressure, it is prone to rupture, leakage or short service life, which cannot meet the needs of customers.

### 3. Summary of the Invention

In order to solve the above problems, the invention provides a new type of water pipe that can be used under both high and low water pressure conditions, can withstand high water pressure and can be extended to a set length under low water pressure conditions to meet customer needs.

The invention is realized by the following technical solutions: a new type of water pipe, comprising:
a compressible and foldable axial elastic corrugated inner pipe, with a drainage channel inside; the compressible and foldable axial elastic corrugated inner pipe is composed of multiple coaxial continuous annular folding structures, and can be compressed, folded, and geometrically extended and elongated along the axial direction under the action of external forces;
an elastic braided layer, which is located outside the compressible and foldable axial elastic corrugated inner pipe, and the elastic braided layer adopts a composite braided structure;
an elastic outer layer, with high elasticity, which is located outside the elastic braided layer, and the elastic braided layer is inside the elastic outer layer;
the elastic outer layer and the surface area of an outer bending ring of the compressible and foldable axial elastic corrugated inner pipe that is not covered by the elastic braided layer are connected to each other, to form a tightly integrated overall tubular structure;
the compressible and foldable axial elastic corrugated inner pipe, elastic braided layer and elastic outer layer are coupled with each other to form a water pipe, and enable the water pipe to achieve limited elongation along the axial direction under the action of water pressure, limit radial extension, and can quickly retract back to its original size when the pressure is released.

Preferably, the annular folding structure comprises outer bending rings, inner bending rings, and membrane walls, so that the corrugated pipe has geometric deformation elasticity in the axial direction; when the external force in the compressed or stretched state is released, the corrugated pipe can automatically return to its original length;
the elastic outer layer is composed of polymer elastic material, which is thermoplastic elastomer TPR, TPE, TPU, SEBS, natural latex or synthetic latex, wherein the thickness of the elastic outer layer is 0.5-5 mm.

Preferably, the elastic braided layer is woven from multiple yarns and multiple elastic yarns;
the multiple elastic yarns are distributed in parallel along the axial direction in the braided layer and are covered by a braided layer made of yarns;
the elastic braided layer can limit lateral extension and achieve limited longitudinal elongation.

Preferably, the outer bending ring and the inner bending ring of the compressible and foldable axial elastic corrugated inner pipe are composed of an arc structure of 0.2-5 mm, and the wall thicknesses a and b of the arc structure are greater than the thickness c of the membrane wall; the cross-sectional structure of the membrane wall is a dumbbell shape; the membrane wall is thin in the middle, and thickened at the connection position with the outer bending ring and the inner bending ring;
the diameter of the inner folding ring of the compressible and foldable axial elastic corrugated inner pipe is 3 mm-30 mm, and the diameter of the outer folding ring thereof is 5 mm-35 mm;
the thickness of the arc structure is 0.3 mm-5 mm, and the thickness of the membrane wall is 0.1 mm-3 mm; in the compressible and foldable axial elastic corrugated inner pipe, the angle α between two adjacent membrane walls is set to 10°-60° in the natural state;
the above settings can enable the axial elastic corrugated pipe to obtain axial geometric elasticity and a compression ratio of 1.5-8 times, that is, the length of the axial elastic corrugated pipe in the extended state is 1.5-8 times in the compressed state;
the material of the compressible and foldable axial elastic corrugated inner pipe (3) is a high-toughness thermoplastic polymer material, and PET, PP, PE, PS, and ABS can be selected.

Preferably, the elastic braided layer is woven from multiple elastic yarns and corresponding 2n times the number of yarns outside the compressible and foldable axial elastic corrugated inner pipe;
the elastic yarns are distributed in parallel along the axial direction in the braided layer and are covered by a yarn braided layer, thereby limiting the extension of the elastic braid layer in the radial direction and the ability to obtain limited elongation in the axial direction;
the number of yarns in the elastic braided layer is an even number of 6-48, and the specification is 200D-2000D;
the quantity of the elastic yarn is 1/(2n) times the corresponding number of yarns, and the specification of the elastic yarn is 0.25 mm-2 mm in diameter;
the elastic yarn is made of high elastic rubber yarn or latex yarn;
the maximum axial elongation limit of the elastic braid layer can be achieved by adjusting the angle β of the bias yarn during braiding; the angle of β is set to less than 180 degrees, but greater than 120 degrees; the larger the β value, the stronger its axial elongation capability.

A new type of water pipe according to the invention, comprising:
a compressible and foldable axial elastic corrugated inner pipe, with a drainage channel inside; the compressible and foldable axial elastic corrugated inner pipe is composed of multiple coaxial continuous annular folding structures, and can be compressed, folded, and geometrically extended and elongated along the axial direction under the action of external forces;
a braided layer capable of geometric deformation and elongation, which is located outside the compressible and foldable axial elastic corrugated inner pipe; the braided layer adopts crochet method to form a relatively loose and flat polygonal braided structure;
an elastic outer layer, with high elasticity, which is located outside the braided layer, and the braided layer is inside the elastic outer layer;
the elastic outer layer and the surface area of an outer bending ring of the compressible and foldable axial elastic corrugated inner pipe that is not covered by the elastic braided layer are connected to each other, to form a tightly integrated overall tubular structure;
the compressible and foldable axial elastic corrugated inner pipe, braided layer and elastic outer layer are coupled with each other to form a water pipe, and enable the water pipe to achieve limited elongation along the axial direction under the action of water pressure, limit radial extension, and can quickly retract back to its original size when the pressure is released.

Preferably, the annular folding structure comprises outer bending rings, inner bending rings, and membrane walls, so that the corrugated pipe has geometric deformation elasticity in the axial direction; when the external force in the compressed or stretched state is released, the corrugated pipe can automatically return to its original length;
the elastic outer layer is composed of polymer elastic material, which is thermoplastic elastomer TPR, TPE, TPU, SEBS, natural latex or synthetic latex, wherein the thickness of the elastic outer layer is 0.5-5 mm.

The polygonal braided structure is arranged axially along the surface of the elastic corrugated inner pipe;
the polygonal braided structure can produce geometric deformation as the axial elastic corrugated pipe is extended or shortened, so that the braided structure can adjust its shape according to the state of the axial elastic corrugated inner pipe;
when the axial elastic corrugated inner pipe is compressed, the polygonal braided structure is compressed into a flatter shape accordingly;
when the axial elastic corrugated inner pipe is stretched or elongated, the polygonal braided structure becomes longitudinally lengthened and tensioned accordingly;
the braided layer limits the axial extension of the elastic corrugated inner pipe while achieving limited axial elongation;
the outer bending ring and the inner bending ring of the compressible and foldable axial elastic corrugated inner pipe are composed of an arc structure of 0.2-5 mm, and the wall thicknesses a and b of the arc structure are greater than the thickness c of the membrane wall; the cross-sectional structure of the membrane wall is a dumbbell shape; the membrane wall is thin in the middle, and thickened at the connection position with the outer bending ring and the inner bending ring;
the diameter of the inner folding ring of the compressible and foldable axial elastic corrugated inner pipe is 3 mm-30 mm, and the diameter of the outer folding ring thereof is 5 mm-35 mm;
the thickness of the arc structure is 0.3 mm-5 mm, and the thickness of the membrane wall is 0.1 mm-3 mm; in the compressible and foldable axial elastic corrugated inner pipe, the angle α between two adjacent membrane walls is set to 10°-60° in the natural state;
the above settings can enable the axial elastic corrugated pipe to obtain axial geometric elasticity and a compression ratio of 1.5-8 times, that is, the length of the axial elastic corrugated pipe in the extended state is 1.5-8 times in the compressed state;
the material of the compressible and foldable axial elastic corrugated inner pipe is a high-toughness thermoplastic polymer material, and PET, PP, PE, PS, and ABS can be selected.

A new type of water pipe according to the invention, comprising:
a compressible and foldable axial elastic corrugated inner pipe, with a drainage channel inside; the compressible and foldable axial elastic corrugated inner pipe is composed of multiple coaxial continuous annular folding structures, and can be compressed, folded, and geometrically extended and elongated along the axial direction under the action of external forces;
a braided layer, which is located outside the compressible and foldable axial elastic corrugated inner pipe; the braided layer capable of geometric deformation uses a circumferential bias braiding method to form a relatively flat rhombus braided structure along the surface of the compressible and foldable axial elastic corrugated pipe;
an elastic outer layer, with high elasticity, which is located outside the braided layer, and the braided layer is inside the elastic outer layer;
the elastic outer layer and the surface area of an outer bending ring of the compressible and foldable axial elastic corrugated inner pipe that is not covered by the elastic braided layer are connected to each other, to form a tightly integrated overall tubular structure;
the compressible and foldable axial elastic corrugated inner pipe, braided layer and elastic outer layer are coupled with each other to form a water pipe, and enable the water pipe to achieve limited elongation along the axial direction under the action of water pressure, limit radial extension, and can quickly retract back to its original size when the pressure is released.

Preferably, the annular folding structure comprises outer bending rings, inner bending rings, and membrane walls, so that the corrugated pipe has geometric deformation elasticity in the axial direction; when the external force in the compressed or stretched state is released, the corrugated pipe can automatically return to its original length;
the elastic outer layer is composed of polymer elastic material, which is thermoplastic elastomer TPR, TPE, TPU, SEBS, natural latex or synthetic latex, wherein the thickness of the elastic outer layer is 0.5-5 mm.
the rhombus braided structure is made of multiple annular yarns interwoven in a circumferential manner, and can produce geometric deformation as the axial elastic corrugated pipe is extended or shortened, so that the rhombus braided structure can adjust its shape according to the state of the axial elastic corrugated inner pipe;
an oblique intersection angle β is formed between the annular yarns; the maximum axial elongation limit of the braided layer can be achieved by adjusting the bias angle β during braiding; the angle of β is set to be less than 180 degrees, but greater than 120 degrees; the larger the β value, the stronger its axial geometric elongation capability; the braided layer limits the radial extension of the axial elastic corrugated inner pipe while achieving limited axial elongation;
when the axial elastic bellows is compressed, the rhombus braided structure is compressed into a flatter shape accordingly, that is, the angle β between the multiple annular yarns becomes larger;
when the axial elastic corrugated pipe is stretched or elongated, the rhombus braided structure becomes longitudinally larger and tensioned accordingly; that is, the angle β between the multiple annular yarns becomes smaller;
the outer bending ring and the inner bending ring of the compressible and foldable axial elastic corrugated inner pipe are composed of an arc structure of 0.2-5 mm, and the wall thicknesses a and b of the arc structure are greater than the thickness c of the membrane wall; the cross-sectional structure of the membrane wall is a dumbbell shape; the membrane wall is thin in the middle, and thickened at the connection position with the outer bending ring and the inner bending ring;
the diameter of the inner folding ring of the compressible and foldable axial elastic corrugated inner pipe is 3 mm-30 mm, and the diameter of the outer folding ring thereof is 5 mm-35 mm;
the thickness of the arc structure is 0.3 mm-5 mm, and the thickness of the membrane wall is 0.1 mm-3 mm; in the compressible and foldable axial elastic corrugated inner pipe, the angle α between two adjacent membrane walls is set to 10°-60° in the natural state;
the above settings can enable the axial elastic corrugated pipe to obtain axial geometric elasticity and a compression ratio of 1.5-8 times, that is, the length of the axial elastic corrugated pipe in the extended state is 1.5-8 times in the compressed state;
the material of the compressible and foldable axial elastic corrugated inner pipe is a high-toughness thermoplastic polymer material, and PET, PP, PE, PS, and ABS can be selected.

Preferably, it also comprises joints, and the joints are respectively provided at both ends of the water pipe;
the joint comprises a water inlet connection device connected to the faucet and a water outlet connection device connected to the ball valve or water gun; the external interface of the joint adopts a quick-connect interface, an external screw interface, or an internal screw interface.

The beneficial effects of the invention are: the new type of water pipe according to the invention has a unique three-layer structure: an axial elastic corrugated inner pipe, an elastic braided layer and an elastic outer layer, which allows automatic stretching to a set length under low water pressure, and effectively limits axial extension under high water pressure to enhance anti-blasting performance. It can be used under both high and low water pressure conditions, and can withstand high water pressure and can be extended to a set length under low water pressure conditions to meet customer needs.

### 4. BRIEF DESCRIPTION OF ACCOMPANY DRAWINGS

In order to explain the technical solutions of the embodiments in the invention more clearly, the drawings that need to be used in the embodiments will be introduced hereinafter. It should be understood that the following drawings only show certain embodiments of the invention, and therefore should not be regarded as limiting the scope. For those of ordinary skill in the art, other drawings may be obtained from these drawings without creative efforts.

FIG. 1 is a structural diagram of the new type of water pipe when it is stretched by fluid pressure according to the invention;

FIG. 2 is a structural diagram of the new type of water pipe when it is not extended according to the invention;

FIG. 3 is an axial cross-sectional view of the new type of water pipe when it is stretched by fluid pressure according to the invention;

FIG. 4 is an axial cross-sectional view of the new type of water pipe when it is not stretched according to the invention;

FIG. 5 is a structural diagram of the compressible and foldable axial elastic corrugated inner pipe according to the invention;

FIG. 6 is a partial enlarged view of the compressible and foldable axial elastic corrugated inner pipe according to the invention;

FIG. 7 is a structural diagram of the elastic braid layer according to the invention;

FIG. 8 is a partial enlarged view of the elastic braid layer according to the invention;

FIG. 9 is a structural diagram that the elastic braid layer replaces the technical solution when it is stretched by fluid pressure according to the invention;

FIG. 10 is a structural diagram that the elastic braid layer replaces the technical solution when it is not stretched according to the invention;

FIG. 11 is a braiding structure diagram that the elastic braid layer replaces the technical solution according to the invention;

FIG. 12 is a structural diagram that the elastic braid layer replaces the technical solution when it is stretched by fluid pressure according to the invention;

FIG. 13 is a structural diagram that the elastic braid layer replaces the technical solution when it is not stretched according to the invention;

FIG. 14 is a braiding structure diagram that the elastic braid layer replaces the technical solution according to the invention;

FIG. 15 shows that both ends of the new type of water pipe according to the invention are equipped with internal thread interfaces and ball valve outlets;

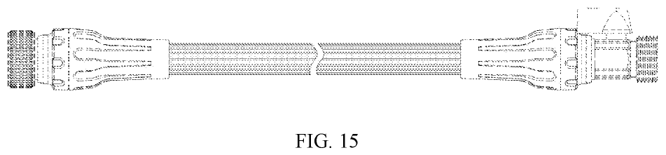

FIG. 16 shows that both ends of the new type of water pipe according to the invention are equipped with quick connectors and ball valve outlets;

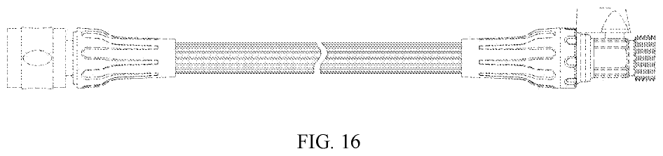

FIG. 17 shows that both ends of the new type of water pipe according to the invention are equipped with quick connectors;

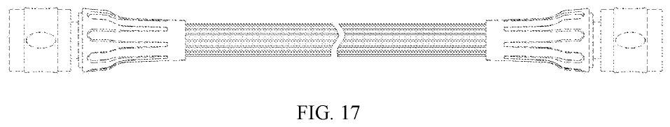

In the figures:
1 refers to the elastic outer layer; 2 refers to the elastic braided layer; 3 refers to the compressible and foldable axial elastic corrugated inner pipe; 4 refers to the polygonal braided structure; 5 refers to the rhombus braided structure; 31 refers to the outer bending ring; 32 refers to the inner bending ring; 33 refers to the first membrane wall; 34 refers to the second membrane wall; 21 refers to the elastic yarn; 22 refers to the first yarn; 23 refers to the second yarn; 51 refers to the first annular yarn; 52 refers to the second annular yarn.

### 5. SPECIFIC EMBODIMENT OF THE INVENTION

All the features disclosed in the specification, or all disclosed methods or steps in the process, except for mutually exclusive features and/or steps, can be combined in any manner.

Any feature disclosed in the specification (including any appended claims, abstract and drawings), unless specifically stated, can be replaced by other equivalent or equivalent alternative features. That is, unless otherwise stated, each feature is just one example of a series of equivalent or similar features.

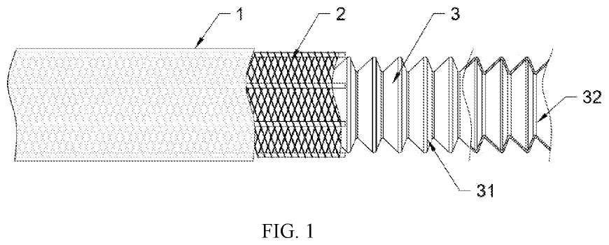

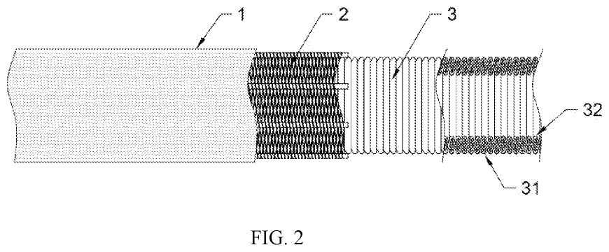

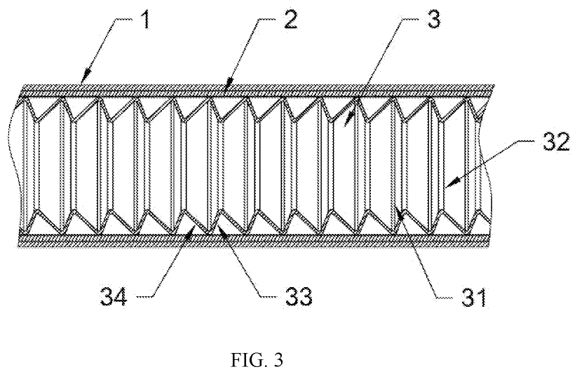

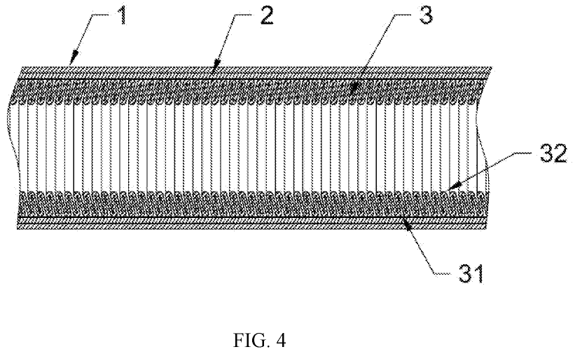

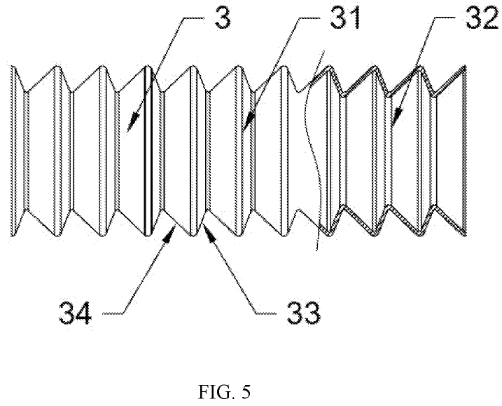

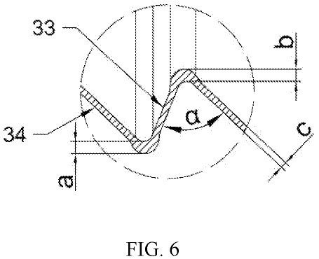

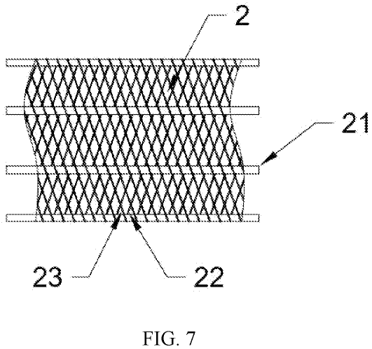

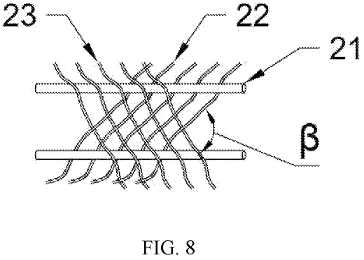

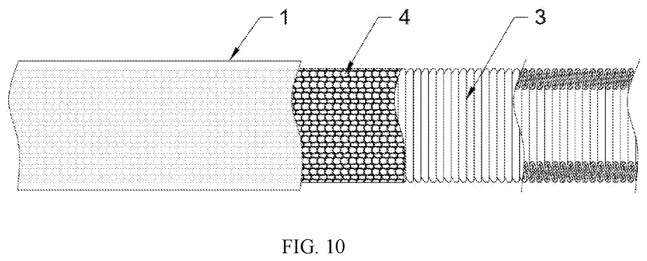

As shown in FIGS. 1-10, a new type of water pipe according to the invention, comprising a compressible and foldable axial elastic corrugated inner pipe 3, an elastic braided layer 2, and an elastic outer layer 1; the compressible and foldable axial elastic corrugated inner pipe 3 is provided with a drainage channel inside; the elastic braided layer 2 is provided on the outer surface of the compressible and foldable axial elastic corrugated inner pipe 3, and the elastic outer layer is provided on the elastic fabric reinforcement layer;
the elastic outer layer and the surface area of an outer bending ring 31 of the compressible and foldable axial elastic corrugated inner pipe 3 that is not covered by the elastic braided layer are connected to each other, to form a tightly integrated overall tubular structure;
the three-layer structure of the new type of water pipe is coupled with each other and can be extended in the axial direction under low and high water pressures, limiting axial extension. When the fluid in the pipe is depressurized, it can quickly retract back to its original size.

The compressible and foldable axial elastic corrugated inner pipe 3 is composed of multiple coaxial continuous annular folding structures, and can be compressed, folded, and geometrically extended and elongated along the axial direction under the action of external forces;
the annular folding structure comprises outer bending rings 31, inner bending rings 32, and membrane walls, and the membrane wall comprises a first membrane wall 33 and a second membrane wall 34, so that the corrugated pipe has geometric deformation elasticity in the axial direction; when the external force in the compressed or stretched state is released, the corrugated pipe can automatically return to its original length.

The elastic braided layer 2 is composed of multiple first yarns 22, second yarns 23 and multiple elastic yarns 21; the elastic yarns 21 are distributed in parallel along the axial direction in the braided layer and are covered by a yarn braided layer, thereby limiting the extension of the elastic braid layer 2 in the radial direction and the ability to obtain limited elongation in the axial direction;

The elastic outer layer 1 has high elasticity characteristics and can produce strong resilience when the new type of water pipe is extended in the axial direction.

The material of the compressible and foldable axial elastic corrugated inner pipe 3 is a high-toughness thermoplastic polymer material, and the outer bending ring 31 and the inner bending ring 32 of the compressible and foldable axial elastic corrugated inner pipe 3 are composed of an arc structure of 0.2-5 mm.

The wall thicknesses a and b of the arc structure are greater than the thickness c of the membrane wall; the cross-sectional structure of the membrane wall is a dumbbell shape (that is, the membrane wall is thin in the middle, and thickened at the connection position with the outer bending ring 31 and the inner bending ring 32), so that the corrugated pipe has geometric deformation elasticity in the axial direction; when the external force in the compressed or stretched state is released, the corrugated pipe can automatically return to its original length.

The diameter of the inner bending ring 32 of the compressible and foldable axial elastic corrugated inner pipe 3 is preferably 5 mm-30 mm, and the diameter of the outer bending ring is preferably 3 mm-35 mm; the thickness of the arc structure is preferably 0.3 mm-5 mm, and the thickness of the first membrane wall 33 and the second membrane wall 34 is preferably 0.1 mm-3 mm; in the compressible and foldable axial elastic corrugated inner pipe, the angle α between two adjacent membrane walls is set to 10°-60° in the natural state;
the above settings can enable the axial elastic corrugated pipe to obtain axial geometric elasticity and a compression ratio of 1.5-8 times, that is, the length of the axial elastic corrugated pipe in the extended state is 1.5-8 times in the compressed state; the material of the compressible and foldable axial elastic corrugated inner pipe 3 is a high-toughness thermoplastic polymer material, and PET, PP, PE, PS, and ABS can be selected. Preparation of the compressible and foldable axial elastic corrugated inner pipe 3: it can be prepared by thermoplastic processing with extruder equipment and special molds.

The elastic braided layer 2 is woven from multiple elastic yarns 21 and corresponding 2n times the number of the first yarns 22 and the second yarns 23 outside the compressible and foldable axial elastic corrugated inner pipe 3; specifically, in order to better weave the elastic braided layer, an elastic layer can be extruded or coated on the outer surface of the compressible and foldable axial elastic corrugated inner pipe 3 first, then braided, and finally the elastic layer can be extruded or coated on the braided layer;

The elastic yarns 21 are distributed in parallel along the axial direction in the braided layer and are covered by a yarn braided layer, thereby limiting the extension of the elastic braid layer 2 in the radial direction and the ability to obtain limited elongation in the axial direction. Preparation of the elastic braided layer 2: fully stretch a compressible and foldable axial elastic corrugated inner pipe 3 and load it into a special braiding machine (1.5-8 times in the compressed and folded state), at the same time stretch the multiple elastic yarns 21 to 1.5-8 times the compression ratio of the foldable pipe and load the multiple yarns into a special braiding machine for braiding preparation. In this way, a compressed semi-finished product with an elastic braided layer 2 on the surface and a compressible and foldable axial elastic corrugated inner pipe 3 can be obtained.

The number of yarns in the elastic braided layer 2 is an even number of 6-48, the material can be made of polyester, polypropylene, nylon and other high-strength yarns, and the specification is 200D-2000D.

The quantity of the elastic yarn 21 is 1/(2n) times the corresponding number of yarns, and the specification of the elastic yarn 21 is 0.25 mm-2 mm in diameter; the elastic yarn 21 is made of high elastic rubber yarn or latex yarn;
the maximum axial elongation limit of the elastic braid layer 2 can be achieved by adjusting the angle β of the bias yarn during braiding; the angle of β is set to less than 180 degrees, but greater than 120 degrees. The larger the β value, the stronger its axial elongation capability; on the contrary, the smaller the β value, the lower the axial elongation capability.

The elastic outer layer 1 is composed of polymer elastic material, which is thermoplastic elastomer TPR, TPE, TPU, SEBS, natural latex or synthetic latex, wherein the thickness of the elastic outer layer is 0.5-5 mm.

Preparation of the outer layer of rubber, extrusion coating method: coat the semi-finished product with the elastic braided layer 2 on the surface of the compressible and foldable axial elastic corrugated inner pipe 3 with a layer of thermoplastic elastomer through extrusion coating equipment;
coating process: coat the semi-finished product that has prepared elastic braided layer 2 on the surface of the compressible and foldable axial elastic corrugated inner pipe 3 with natural latex or synthetic latex one or more times through the coating equipment to form an outer layer of rubber with a set thickness.

It also comprises joints, and the joints are respectively provided at both ends of the water pipe; the joint comprises a water inlet connection device connected to the faucet and a water outlet connection device connected to the ball valve or water gun; the external interface of the joint adopts a quick-connect interface, an external screw interface, or an internal screw interface.

Alternative option 1 for elastic braided layer: the braided layer is composed of multiple yarns using adopting crochet method to form a relatively loose and flat polygonal braided structure 4 arranged axially along the surface of a compressible and foldable axial elastic corrugated inner pipe 3; the loose and flat polygonal braided structure 4 has geometric deformation elasticity, and can compress the polygonal braided structure 4 with the compression of the compressible and foldable axial elastic corrugated inner pipe 3 to forma flatter structure; when the compressible and foldable axial elastic corrugated inner pipe 3 is stretched or elongated, the polygonal braided structure 4 becomes longitudinally lengthened and tensioned accordingly, thereby limiting the axial extension of the inner pipe of the compressible and foldable axial elastic corrugated inner pipe 3 and achieving limited axial elongation.

Alternative option 2 for elastic braided layer: the rhombus braided structure 5 is made of multiple annular yarns interwoven in a circumferential manner, and can produce geometric deformation as the axial elastic corrugated pipe is extended or shortened, so that the rhombus braided structure can adjust its shape according to the state of the axial elastic corrugated inner pipe;
an oblique intersection angle β is formed between the annular yarns; the maximum axial elongation limit of the braided layer 5 can be achieved by adjusting the bias angle β during braiding; the angle of β is set to be less than 180 degrees, but greater than 120 degrees; the larger the β value, the stronger its axial geometric elongation capability; the braided layer limits the radial extension of the axial elastic corrugated inner pipe while achieving limited axial elongation.

Stretching possible under low water pressure:
according to the structure of the mold, adjust the arc structure formed by the compressible and foldable axial elastic corrugated inner pipe 3 and the angle α between the adjacent membrane walls to set the optimal extension length of the corrugated pipe, so that the corrugated pipe has a certain geometric deformation elasticity in the axial direction; that is, when compressed by an external force, the compressible and foldable axial elastic corrugated inner pipe can be folded to the compressed length, and when the compression external force is released, the compressible and foldable axial elastic corrugated inner pipe can automatically return to its original molded length. The size of its geometric deformation elastic force can be adjusted by the wall thickness a and b of the arc structure and the thickness c of the membrane wall; that is, the greater the thickness value of a, b, and c, the greater the geometric deformation elastic force K.

By adjusting the elastic braided layer 2 including the number of elastic yarns 21 and the diameter of the elastic yarns 21, the resilience H of the elastic braided layer can be adjusted;

By adjusting the thickness of the coating rubber of the elastic outer layer 1 and the tensile strength of the formula, the resilience L of the elastic outer layer 1 rubber can be adjusted. The thickness of the rubber coating can first be set to a thickness that is relatively wear-resistant (0.5-3 mm) to meet the need for the water pipe to not be damaged by ground friction during actual use.

When L+H>K is achieved, and the closer the L+H value is to the K value, the smaller fluid pressure needs to be applied in the new type of water pipe to extend the water pipe to the set use length. Based on this principle, we can make a new type of water pipe that can be used in low water pressure scenarios.

Used in high water pressure scenarios:
the elastic braided layer 2 can limit lateral extension and achieve limited longitudinal elongation. The elastic braided layer 2 is tightly wrapped on the outer surface of the compressible and foldable axial elastic corrugated inner pipe 3; therefore, the elastic braided layer 2's characteristic of limiting lateral extension greatly enhances the radial explosion resistance of the compressible and foldable axial elastic corrugated inner pipe 3, and the limited longitudinal elongation of the elastic braided layer 2 also greatly enhances the axial explosion resistance of the compressible and foldable axial elastic corrugated inner pipe 3. The longitudinal elongation limit of the elastic braided layer 2 can be adjusted by the β size of the braided yarn.

By adjusting the number and diameter of the elastic braided layer 2 including multiple yarns, the radial and axial burst resistance values of the compressible and foldable axial elastic corrugated inner pipe 3 are strengthened; the greater the number of yarns and the larger the wire diameter, the greater the anti-burst value. Based on this principle, a new type of water pipe can be made that can be used in high water pressure scenarios.

### Embodiment 1

A new type of water pipe that can stretch under both high and low water pressures:
preparation of the compressible and foldable axial elastic corrugated inner pipe 3: the angle α between two adjacent membrane walls formed by using PE raw materials and molding the compressible and foldable axial elastic corrugated inner pipe 3 through the mold structure design of the extrusion equipment is set to 30°; the wall thickness a and b of the arc structure are set to 0.8 mm, and the thickness c of the membrane wall is set to 0.5 mm; the diameter of the outer bending ring is set to 12 mm, and the inner bending ring to 7 mm; in this way, a compressible and foldable axial elastic corrugated inner pipe 3 with approximately 3 times the geometric deformation elasticity can be produced through extrusion equipment and mold molding. The elastic braided layer 2 adopts 6 latex yarns with a diameter of 0.8 mm; the yarns adopt 24 800D high-strength polyester yarns, including 12 first yarns 22 and 12 second yarns 23; fully stretch a compressible and foldable axial elastic corrugated inner pipe 3 and load it into a special braiding machine (3 times in the compressed and folded state). In the embodiment, the braided layer can be woven in the stretched state of the compressible and foldable axial elastic corrugated inner pipe; then put the elastic yarns 21, the first yarns 22, and the second yarns 23 into a special braiding machine at the same time for braiding; during braiding, the angle β at which the first yarn 22 and the second yarn 23 intersect obliquely is set to 160 degrees, and the elastic yarns 21 are axially parallel and evenly distributed along the surface of the compressible and foldable axial elastic corrugated inner pipe 3; therefore, an elastic braided layer 2 can be produced that limits lateral extension and achieves limited longitudinal elongation. In this way, a compressed compressible and foldable axial elastic corrugated inner pipe 3 semi-finished product with an elastic braided layer 2 on the surface can be obtained.

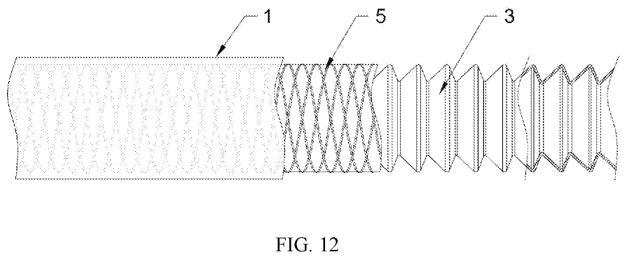

The elastic outer layer 1 is made of TPR thermoplastic elastomer material, and the thickness of the coating rubber is set to 1.5 mm through the mold to ensure sufficient thickness to meet the requirement of the water pipe not being damaged by friction with the ground during actual use. By adjusting the formula, the resilience L of the elastic outer layer of rubber satisfies L+H>K, and the L+H value is getting closer and closer to the K value (H is the resilience of the elastic braided layer, and K is the elasticity of the compressible and foldable axial elastic corrugated inner pipe). After a compressed compressible and foldable axial elastic corrugated inner pipe 3 semi-finished product with an elastic braided layer 2 on the surface is fully compressed, the elastic outer layer of rubber is coated through an extrusion coating mold, and the pipe body of the new type of water pipe is prepared by cooling and shaping, then both ends are equipped with internal thread water inlet joints and ball valve water outlet interfaces (as shown in FIG. 12), in this way, a new type of water pipe can be made that can be used in both high and low water pressure scenarios, achieve limited longitudinal elongation by 3 times, and is wear-resistant, as shown in FIG. 12.

### Embodiment 2

A New type of water pipe used in high water pressure scenarios:
preparation of the compressible and foldable axial elastic corrugated inner pipe 3: the angle α between two adjacent membrane walls formed by using TPU raw materials and molding the compressible and foldable axial elastic corrugated inner pipe 3 through the mold structure design of the extrusion equipment is set to 25°; the wall thickness a and b of the arc structure are set to 2 mm, and the thickness c of the membrane wall is set to 1 mm; the diameter of the outer bending ring is set to 18 mm, and the inner bending ring to 10 mm; in this way, a compressible and foldable axial elastic corrugated inner pipe 3 with approximately 2.5 times the geometric deformation elasticity can be produced through extrusion equipment and mold molding. The elastic braided layer 2 adopts 8 latex yarns with a diameter of 1.2 mm; the yarns adopt 64 1200D high-strength polyester yarns, including 32 first yarns 22 and 32 second yarns 23; fully stretch a compressible and foldable axial elastic corrugated inner pipe 3 and load it into a special braiding machine (4 times in the compressed and folded state). In the embodiment, the braided layer can be woven in the stretched state of the compressible and foldable axial elastic corrugated inner pipe; then put the elastic yarns 21, the first yarns 22, and the second yarns 23 into a special braiding machine at the same time for braiding; during braiding, the angle β at which the first yarn 22 and the second yarn 23 intersect obliquely is set to 150 degrees, and the elastic yarns 21 are axially parallel and evenly distributed along the surface of the compressible and foldable axial elastic corrugated inner pipe 3; therefore, an elastic braided layer 2 can be produced that limits lateral extension and achieves limited longitudinal elongation. In this way, a compressed compressible and foldable axial elastic corrugated inner pipe 3 semi-finished product with an elastic braided layer 2 on the surface can be obtained.

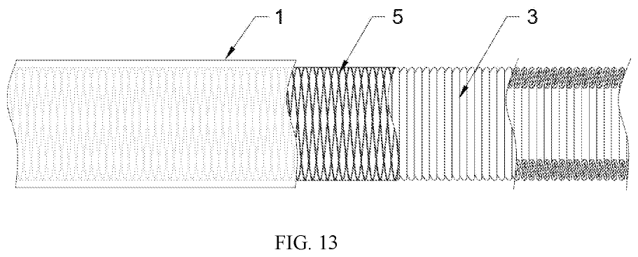

The elastic outer layer 1 is made of SEBS thermoplastic elastomer material, and the thickness of the coating rubber is set to 2 mm through the mold to ensure sufficient thickness to meet the requirement of the water pipe not being damaged by friction with the ground during actual use. By adjusting the formula, the resilience L of the elastic outer layer of rubber satisfies L+H>K, and the L+H value is getting closer and closer to the K value (H is the resilience of the elastic braided layer, and K is the elasticity of the compressible and foldable axial elastic corrugated inner pipe). After a compressed compressible and foldable axial elastic corrugated inner pipe 3 semi-finished product with an elastic braided layer 2 on the surface is fully compressed, the elastic outer layer of rubber is coated through an extrusion coating mold, and the pipe body of the new type of water pipe is prepared by cooling and shaping, then both ends are equipped with internal thread water inlet joints and ball valve water outlet interfaces, in this way, a new type of water pipe can be made that can be used in high water pressure scenarios, achieve limited longitudinal elongation by 2.5 times, and is wear-resistant, as shown in FIG. 13.

### Embodiment 3

A new type of water pipe with alternative technical solutions for the elastic braided layer:
preparation of the compressible and foldable axial elastic corrugated inner pipe 3: the angle α between two adjacent membrane walls formed by using PS raw materials and molding the compressible and foldable axial elastic corrugated inner pipe 3 through the mold structure design of the extrusion equipment is set to 35°; the wall thickness a and b of the arc structure are set to 1 mm, and the thickness c of the membrane wall is set to 0.6 mm; the diameter of the outer bending ring is set to 15 mm, and the inner bending ring to 9 mm; in this way, a compressible and foldable axial elastic corrugated inner pipe 3 with approximately 3.5 times the geometric deformation elasticity can be produced through extrusion equipment and mold molding.

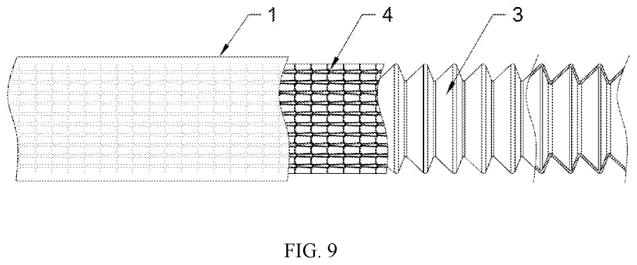

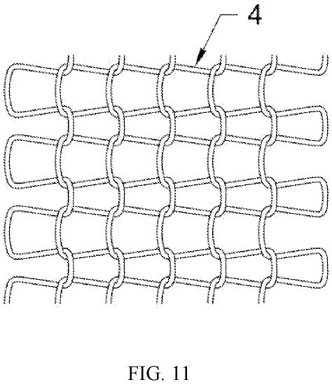

As shown in FIGS. 9-11, the braided layer 4 is composed of 30 1000D high-elastic acrylic yarns using the crochet method to form a relatively loose and flat polygonal braided structure 4 arranged axially along the surface of the compressible and foldable axial elastic corrugated inner pipe 3; during braiding, the braided layer can be woven in the stretched state of the compressible and foldable axial elastic corrugated inner pipe. In this way, a semi-finished product of the braided layer whose surface can produce geometric deformation with the extension and contraction of the compressible and foldable axial elastic corrugated inner pipe 3 can be obtained.

The elastic outer layer 1 adopts a latex coating process; after a compressible and foldable axial elastic corrugated inner pipe 3 semi-finished product with an elastic braided layer on the surface is completely compressed, the thickness of the coating rubber is set to 1 mm through the mold to ensure sufficient thickness to meet the requirement of the water pipe not being damaged by friction with the ground during actual use. By adjusting the formula, the resilience L of the elastic outer layer of rubber satisfies L>K, and the L value is getting closer and closer to the K value. After multiple coatings and encapsulation, it is dried and vulcanized to form the body of the new type of water pipe, then both ends are equipped with internal thread water inlet joints and ball valve water outlet interfaces, in this way, a new type of water pipe can be made that can be used in low water pressure scenarios, achieve limited longitudinal elongation by 3.5 times.

### Embodiment 4

A new type of water pipe with alternative technical solutions for the elastic braided layer:
preparation of the compressible and foldable axial elastic corrugated inner pipe 3: the angle α between two adjacent membrane walls formed by using PP and PE mixed raw materials and molding the compressible and foldable axial elastic corrugated inner pipe 3 through the mold structure design of the extrusion equipment is set to 40°; the wall thickness a and b of the arc structure are set to 0.7 mm, and the thickness c of the membrane wall is set to 0.6 mm; the diameter of the outer bending ring is set to 14 mm, and the inner bending ring to 10 mm; in this way, a compressible and foldable axial elastic corrugated inner pipe 3 with approximately 4 times the geometric deformation elasticity can be produced through extrusion equipment and mold molding.

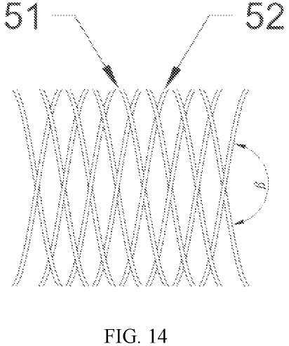

As shown in FIGS. 12-14, in the embodiment, the braided layer 5 adopts a rhombus braided structure 5, which is made of two 1100D polyester high-strength yarns and is woven annularly along the surface of a compressible and foldable axial elastic corrugated inner pipe through a circumferential special braiding machine, including a first annular yarn 51 and a second annular yarn 52, which are circumferentially interwoven and woven along the surface of the compressible axial elastic corrugated pipe; the first annular yarn 51 and the second annular yarn 52 form a gap in the axial direction; however, since the first annular yarn 51 and the second annular yarn 52 have no elastic deformation force, the bias braided structure 5 can stretch in the axial direction but cannot extend in the circumferential direction.

an oblique intersection angle β is formed between the first annular yarn and the second annular yarn; the maximum axial elongation limit of the braided layer 5 can be achieved by adjusting the bias angle β during braiding; the angle of β is set to be less than 180 degrees, but greater than 120 degrees; the larger the β value, the stronger its axial geometric elongation capability. In the embodiment, the angle of β is set to 170 degrees, which can produce 4 times the geometric deformation as the axial elastic corrugated pipe extends or shortens.

The elastic outer layer 1 adopts a latex coating process; after a compressible and foldable axial elastic corrugated inner pipe 3 semi-finished product with an elastic braided layer on the surface is completely compressed, the thickness of the coating rubber is set to 1.2 mm through the mold to ensure sufficient thickness to meet the requirement of the water pipe not being damaged by friction with the ground during actual use. By adjusting the formula, the resilience L of the elastic outer layer of rubber satisfies L>K, and the L value is getting closer and closer to the K value (K is the elasticity of the compressible and foldable axial elastic corrugated inner pipe). After multiple coatings and encapsulation, it is dried and vulcanized to form the body of the new type of water pipe, then both ends are equipped with internal thread water inlet joints and ball valve water outlet interfaces, in this way, a new type of water pipe can be made that can be used in both high and low water pressure scenarios, achieve limited longitudinal elongation by 4 times.

The above are only specific embodiments of the invention, but the protection scope of the invention is not limited thereto. Any modifications or substitutions creative efforts shall all fall within protection scope of the invention. Therefore, the protection scope of the invention should be subject to the protection scope defined by the claims.

1. A new type of water pipe, comprising:
a compressible and foldable axial elastic corrugated inner pipe, with a drainage channel inside; the compressible and foldable axial elastic corrugated inner pipe is composed of multiple coaxial continuous annular folding structures, and can be compressed, folded, and geometrically extended and elongated along the axial direction under the action of external forces;
an elastic braided layer, which is located outside the compressible and foldable axial elastic corrugated inner pipe, and the elastic braided layer adopts a composite braided structure;
an elastic outer layer, with high elasticity, which is located outside the elastic braided layer, and the elastic braided layer is inside the elastic outer layer;
the elastic outer layer and the surface area of an outer bending ring of the compressible and foldable axial elastic corrugated inner pipe that is not covered by the elastic braided layer are connected to each other, to form a tightly integrated overall tubular structure;
the compressible and foldable axial elastic corrugated inner pipe, elastic braided layer and elastic outer layer are coupled with each other to form a water pipe, and enable the water pipe to achieve limited elongation along the axial direction under the action of water pressure, limit radial extension, and can quickly retract back to its original size when the pressure is released.

2. The new type of water pipe of claim 1, wherein the annular folding structure comprises outer bending rings, inner bending rings, and membrane walls, so that the corrugated pipe has geometric deformation elasticity in the axial direction;
when the external force in the compressed or stretched state is released, the corrugated pipe can automatically return to its original length;
the elastic outer layer is composed of polymer elastic material, which is thermoplastic elastomer TPR, TPE, TPU, SEBS, natural latex or synthetic latex, wherein the thickness of the elastic outer layer is 0.5-5 mm.

3. The new type of water pipe of claim 1, wherein the elastic braided layer is woven from multiple yarns and multiple elastic yarns;
the multiple elastic yarns are distributed in parallel along the axial direction in the braided layer and are covered by a braided layer made of yarns; the elastic braided layer can limit lateral extension and achieve limited longitudinal elongation.

4. The new type of water pipe of claim 2, wherein the outer bending ring and the inner bending ring of the compressible and foldable axial elastic corrugated inner pipe are composed of an arc structure of 0.2-5 mm, and the wall thicknesses a and b of the arc structure are greater than the thickness c of the membrane wall; the cross-sectional structure of the membrane wall is a dumbbell shape;
the membrane wall is thin in the middle, and thickened at the connection position with the outer bending ring and the inner bending ring;
the diameter of the inner folding ring of the compressible and foldable axial elastic corrugated inner pipe is 3 mm-30 mm, and the diameter of the outer folding ring thereof is 5 mm-35 mm;
the thickness of the arc structure is 0.3 mm-5 mm, and the thickness of the membrane wall is 0.1 mm-3 mm; in the compressible and foldable axial elastic corrugated inner pipe, the angle α between two adjacent membrane walls is set to 10°-60° in the natural state;
the above settings can enable the axial elastic corrugated pipe to obtain axial geometric elasticity and a compression ratio of 1.5-8 times, that is, the length of the axial elastic corrugated pipe in the extended state is 1.5-8 times in the compressed state;
the material of the compressible and foldable axial elastic corrugated inner pipe is a high-toughness thermoplastic polymer material, and PET, PP, PE, PS, and ABS can be selected.

5. The new type of water pipe of claim 1, wherein the elastic braided layer is woven from multiple elastic yarns and corresponding 2n times the number of yarns outside the compressible and foldable axial elastic corrugated inner pipe;
the elastic yarns are distributed in parallel along the axial direction in the braided layer and are covered by a yarn braided layer, thereby limiting the extension of the elastic braid layer in the radial direction and the ability to obtain limited elongation in the axial direction;
the number of yarns in the elastic braided layer is an even number of 6-48, and the specification is 200D-2000D;
the quantity of the elastic yarn is 1/(2n) times the corresponding number of yarns, and the specification of the elastic yarn is 0.25 mm-2 mm in diameter;
the elastic yarn is made of high elastic rubber yarn or latex yarn;
the maximum axial elongation limit of the elastic braid layer can be achieved by adjusting the angle β of the bias yarn during braiding; the angle of β is set to less than 180 degrees, but greater than 120 degrees; the larger the β value, the stronger its axial elongation capability.

6. A new type of water pipe, comprising:
a compressible and foldable axial elastic corrugated inner pipe, with a drainage channel inside; the compressible and foldable axial elastic corrugated inner pipe is composed of multiple coaxial continuous annular folding structures, and can be compressed, folded, and geometrically extended and elongated along the axial direction under the action of external forces;
a braided layer capable of geometric deformation and elongation, which is located outside the compressible and foldable axial elastic corrugated inner pipe; the braided layer adopts crochet method to form a relatively loose and flat polygonal braided structure;
an elastic outer layer, with high elasticity, which is located outside the braided layer, and the braided layer is inside the elastic outer layer;
the elastic outer layer and the surface area of an outer bending ring of the compressible and foldable axial elastic corrugated inner pipe that is not covered by the elastic braided layer are connected to each other, to form a tightly integrated overall tubular structure;
the compressible and foldable axial elastic corrugated inner pipe, braided layer and elastic outer layer are coupled with each other to form a water pipe, and enable the water pipe to achieve limited elongation along the axial direction under the action of water pressure, limit radial extension, and can quickly retract back to its original size when the pressure is released.

7. The new type of water pipe of claim 6, wherein the annular folding structure comprises outer bending rings, inner bending rings, and membrane walls, so that the corrugated pipe has geometric deformation elasticity in the axial direction;
when the external force in the compressed or stretched state is released, the corrugated pipe can automatically return to its original length;
the elastic outer layer is composed of polymer elastic material, which is thermoplastic elastomer TPR, TPE, TPU, SEBS, natural latex or synthetic latex, wherein the thickness of the elastic outer layer is 0.5-5 mm.
the polygonal braided structure is arranged axially along the surface of the elastic corrugated inner pipe;
the polygonal braided structure can produce geometric deformation as the axial elastic corrugated pipe is extended or shortened, so that the braided structure can adjust its shape according to the state of the axial elastic corrugated inner pipe;
when the axial elastic corrugated inner pipe is compressed, the polygonal braided structure is compressed into a flatter shape accordingly;
when the axial elastic corrugated inner pipe is stretched or elongated, the polygonal braided structure becomes longitudinally lengthened and tensioned accordingly;
the braided layer limits the axial extension of the elastic corrugated inner pipe while achieving limited axial elongation;
the outer bending ring and the inner bending ring of the compressible and foldable axial elastic corrugated inner pipe are composed of an arc structure of 0.2-5 mm, and the wall thicknesses a and b of the arc structure are greater than the thickness c of the membrane wall; the cross-sectional structure of the membrane wall is a dumbbell shape; the membrane wall is thin in the middle, and thickened at the connection position with the outer bending ring and the inner bending ring;
the diameter of the inner folding ring of the compressible and foldable axial elastic corrugated inner pipe is 3 mm-30 mm, and the diameter of the outer folding ring thereof is 5 mm-35 mm;
the thickness of the arc structure is 0.3 mm-5 mm, and the thickness of the membrane wall is 0.1 mm-3 mm; in the compressible and foldable axial elastic corrugated inner pipe, the angle α between two adjacent membrane walls is set to 10°-60° in the natural state;
the above settings can enable the axial elastic corrugated pipe to obtain axial geometric elasticity and a compression ratio of 1.5-8 times, that is, the length of the axial elastic corrugated pipe in the extended state is 1.5-8 times in the compressed state;
the material of the compressible and foldable axial elastic corrugated inner pipe is a high-toughness thermoplastic polymer material, and PET, PP, PE, PS, and ABS can be selected.

8. A new type of water pipe, comprising:
a compressible and foldable axial elastic corrugated inner pipe, with a drainage channel inside; the compressible and foldable axial elastic corrugated inner pipe is composed of multiple coaxial continuous annular folding structures, and can be compressed, folded, and geometrically extended and elongated along the axial direction under the action of external forces;
a braided layer, which is located outside the compressible and foldable axial elastic corrugated inner pipe; the braided layer capable of geometric deformation uses a circumferential bias braiding method to form a relatively flat rhombus braided structure along the surface of the compressible and foldable axial elastic corrugated pipe;
an elastic outer layer, with high elasticity, which is located outside the braided layer, and the braided layer is inside the elastic outer layer;
the elastic outer layer and the surface area of an outer bending ring of the compressible and foldable axial elastic corrugated inner pipe that is not covered by the elastic braided layer are connected to each other, to form a tightly integrated overall tubular structure;
the compressible and foldable axial elastic corrugated inner pipe, braided layer and elastic outer layer are coupled with each other to form a water pipe, and enable the water pipe to achieve limited elongation along the axial direction under the action of water pressure, limit radial extension, and can quickly retract back to its original size when the pressure is released.

9. The new type of water pipe of claim 8, wherein the annular folding structure comprises outer bending rings, inner bending rings, and membrane walls, so that the corrugated pipe has geometric deformation elasticity in the axial direction;
when the external force in the compressed or stretched state is released, the corrugated pipe can automatically return to its original length;
the elastic outer layer is composed of polymer elastic material, which is thermoplastic elastomer TPR, TPE, TPU, SEBS, natural latex or synthetic latex, wherein the thickness of the elastic outer layer is 0.5-5 mm.
the rhombus braided structure is made of multiple annular yarns interwoven in a circumferential manner, and can produce geometric deformation as the axial elastic corrugated pipe is extended or shortened, so that the rhombus braided structure can adjust its shape according to the state of the axial elastic corrugated inner pipe;
an oblique intersection angle β is formed between the annular yarns; the maximum axial elongation limit of the braided layer can be achieved by adjusting the bias angle β during braiding; the angle of β is set to be less than 180 degrees, but greater than 120 degrees; the larger the β value, the stronger its axial geometric elongation capability; the braided layer limits the radial extension of the axial elastic corrugated inner pipe while achieving limited axial elongation;
when the axial elastic bellows is compressed, the rhombus braided structure is compressed into a flatter shape accordingly, that is, the angle β between the multiple annular yarns becomes larger;
when the axial elastic corrugated pipe is stretched or elongated, the rhombus braided structure becomes longitudinally larger and tensioned accordingly; that is, the angle β between the multiple annular yarns becomes smaller;
the outer bending ring and the inner bending ring of the compressible and foldable axial elastic corrugated inner pipe are composed of an arc structure of 0.2-5 mm, and the wall thicknesses a and b of the arc structure are greater than the thickness c of the membrane wall; the cross-sectional structure of the membrane wall is a dumbbell shape; the membrane wall is thin in the middle, and thickened at the connection position with the outer bending ring and the inner bending ring;
the diameter of the inner folding ring of the compressible and foldable axial elastic corrugated inner pipe is 3 mm-30 mm, and the diameter of the outer folding ring thereof is 5 mm-35 mm;
the thickness of the arc structure is 0.3 mm-5 mm, and the thickness of the membrane wall is 0.1 mm-3 mm; in the compressible and foldable axial elastic corrugated inner pipe, the angle α between two adjacent membrane walls is set to 10°-60° in the natural state;
the above settings can enable the axial elastic corrugated pipe to obtain axial geometric elasticity and a compression ratio of 1.5-8 times, that is, the length of the axial elastic corrugated pipe in the extended state is 1.5-8 times in the compressed state;
the material of the compressible and foldable axial elastic corrugated inner pipe is a high-toughness thermoplastic polymer material, and PET, PP, PE, PS, and ABS can be selected.

10. The new type of water pipe of claim 1, wherein it also comprises joints, and the joints are respectively provided at both ends of the water pipe;
the joint comprises a water inlet connection device connected to the faucet and a water outlet connection device connected to the ball valve or water gun; the external interface of the joint adopts a quick-connect interface, an external screw interface, or an internal screw interface.
